(19) United States
(12) Patent Application Publication
(10) Pub. No.: US 2024/0363972 A1
(43) Pub. Date: Oct. 31, 2024

(54) ELECTROCHEMICAL ENERGY STORAGE ELEMENT

(71) Applicant: VARTA Microbattery GmbH, Ellwangen Jagst (DE)

(72) Inventors: Verena DREWS, Giengen (DE); Martin ELMER, Ellwangen (DE)

(21) Appl. No.: 18/644,155

(22) Filed: Apr. 24, 2024

(30) Foreign Application Priority Data
Apr. 26, 2023 (EP) 23170134.3

(51) Int. Cl. H01M 50/528; H01M 50/107; H01M 50/152; H01M 50/159; H01M 50/56

(52) U.S. Cl. CPC H01M 50/528; H01M 50/107; H01M 50/152; H01M 50/159; H01M 50/56

(57) ABSTRACT

An electrochemical energy storage element includes an electrode-separator assembly enclosed in a housing that includes a closure assembly. The closure assembly includes a first sheet metal part having a first side, an opposite second side, and an aperture. The closure assembly also includes a second sheet metal part having a contact segment extending on the first side of the first sheet metal part, a fixing segment extending on the second side of the first sheet metal part, and a tubular feedthrough connecting the connecting the contact segment and the fixing segment through the aperture. An electrically insulating seal is disposed between the first sheet metal part and the second sheet metal part. A first part of the fixing segment is formed as a bottom that closes the tubular feedthrough on the second side of the first sheet metal part.

### CROSS REFERENCE TO RELATED APPLICATIONS

This application claims benefit to European Patent Application No. EP 23170134.3, filed on Apr. 26, 2023, which is hereby incorporated by reference herein.

### FIELD

The present disclosure relates to an electrochemical energy storage element.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, between which a separator is arranged. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte. The separator thus prevents direct contact between the electrodes. At the same time, however, it enables electrical charge equalization between the electrodes.

If the discharge is reversible, i.e. if it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example.

Furthermore, the electrodes can comprise an electrode binder (e.g. polyvinylidene fluoride (PVDF) or another polymer, such as carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells usually comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly when manufacturing a lithium-ion cell. The electrodes and separators are often, but by no means necessarily, connected under pressure, possibly also by lamination or by adhesive bonding. The basic functionality of the cell can then be established by impregnating the assembly with the electrolyte.

In many embodiments, the electrode-separator assembly is formed in the form of a winding or is processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in electric tools, lithium-ion cells with the highest possible energy density are required that are also capable of withstanding high currents during charging and discharging.

Cells for the applications mentioned are often designed as cylindrical round cells, for example with a form factor of 21×70 (diameter*height in mm). Cells of this type always comprise an assembly in the form of a winding. Modern lithium-ion cells of this form factor can achieve an energy density of up to 270 Wh/kg.

WO 2017/215900 A1 describes cylindrical round cells in which the electrode-separator assembly and its electrodes are ribbon-shaped and in the form of a winding. The electrodes each have current collectors loaded with electrode material. Oppositely polarized electrodes are arranged offset to each other within the electrode-separator assembly so that longitudinal edges of the current collectors of the positive electrodes protrude from one side and longitudinal edges of the current collectors of the negative electrodes protrude from another side of the winding. For electrical contacting of the current collectors, the cell has a contact sheet metal member that sits on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

Electrochemical cells which have electrode windings such as those in WO 2017/215900 A1 are also known from WO 2022/167586 A1. It is also described that a free edge of a current collector is connected to a contact sheet metal member. This contact sheet metal member comprises a central protrusion which is guided through an aperture in the cell housing and serves as a pole bushing. However, assembly of this cell is difficult. Welding the current collectors to the contact sheet metal member is virtually impossible.

Another cell design is known from U.S. Pat. No. 7,364,817 B2, in which current is drawn off from a cell via a contact sheet metal member. This contact sheet metal member is connected to a multi-part lid assembly via a separate current conductor. However, the separate current conductor is inevitably accompanied by a dead volume within the cell, which has a negative effect on its energy density.

### SUMMARY

In an embodiment, the present disclosure provides an electrochemical energy storage element. The electrochemical energy storage element includes an electrode-separator assembly comprising a current collector and a housing enclosing the electrode-separator assembly. The housing includes a closure assembly, the closure assembly including (a) a first sheet metal part having a first side, an opposite second side, and an aperture, (b) a second sheet metal part having a contact segment extending on the first side of the first sheet metal part, a fixing segment extending on the second side of the first sheet metal part, and a tubular feedthrough connecting the connecting the contact segment and the fixing segment through the aperture, and (c) an electrically insulating seal disposed between the first sheet metal part and the second sheet metal part. A first part of the fixing segment is formed as a bottom that closes the tubular feedthrough on the second side of the first sheet metal part. The bottom includes an internal side and an external side, the internal side directed in a direction of the feedthrough and the external side directed in an opposite direction. A second part of the fixing segment is formed as a projection configured to provide a form-fitting fixation of the tubular feedthrough in the aperture. The first side of the first metal sheet part and the contact segment delimit a first gap, and the second side of the first metal sheet and the projection delimit a second gap. The electrically insulating seal fills the first gap and the second gap to separate the first and second sides in a gas- and/or liquid-tight manner. The electrode-separator assembly is connected to the external side of the bottom by a connection formed via either (i) the current collector being welded directly to the external side of the bottom, or (ii) the current collector being welded to a current conductor that is welded directly to the external side of the bottom.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a closure assembly of an energy storage element;

FIG. 2 is a schematic illustration of the manufacture of a closure assembly according to FIG. 1;

FIG. 3 is a schematic illustration of the manufacture of an embodiment of the closure assembly of an energy storage element;

FIG. 4 illustrates a possible embodiment of an energy storage element together with the closure assembly shown in FIG. 1;

FIG. 5 illustrates a preferred example of an electrode-separator assembly, which is part of the energy storage element, and its components; and

FIG. 6 is a schematic illustration of the manufacture of a further embodiment of the closure assembly of an energy storage element.

### DETAILED DESCRIPTION

The present disclosure provides for constructing electrochemical energy storage elements with as little dead volume as possible, which are characterized by simple assembly and low-cost components.

### Energy Storage Element

The present disclosure provides an energy storage element that comprises an electrode-separator assembly and a housing which encloses the electrode-separator assembly, and is characterized by the immediately following features a. to j:
a. The housing comprises a closure assembly.
b. The closure assembly comprises a first metal sheet member having a first side, an opposite second side and an aperture;
c. The closure assembly comprises a second metal sheet member having a contact segment, a fixing segment and a tubular feedthrough, wherein the contact segment extends on the first side and the fixing segment extends on the second side of the first metal sheet member and the tubular feedthrough connects the two segments through the aperture;
d. The closure assembly comprises an electrically insulating seal disposed between the first and second metal sheet members and electrically insulating them from each other;
e. A first part of the fixing segment is formed as a bottom which closes the tubular feedthrough on the second side, wherein the bottom has an internal side directed towards the feedthrough and an external side directed in an opposite direction and;
f. A second part of the fixing segment is formed as a projection, which ensures a form-fitting fixation of the tubular feedthrough in the aperture and thus that the first sheet metal part and the second sheet metal part firmly hold together;
g. The first side of the first metal sheet part and the contact segment delimit a first gap;
h. The second side of the first metal sheet and the overhang delimit a second gap;
i. The seal fills the first and second gap in such a way that the first side is separated from the second side in a gas- and/or liquid-tight manner; and
j. The electrode-separator assembly is welded to the external side of the bottom, which closes the tubular feedthrough on the second side.

The contact segment is used, for example, to make electrical contact to an external electrical consumer or an electrical conductor via which the energy storage element is electrically coupled to other energy storage elements. For example, a current conductor can be welded onto the contact segment in order to connect the energy storage element in series or in parallel with other energy storage elements. The fixing segment is used to make electrical contact with the electrode-separator assembly and, in particular, to fix the second sheet metal part in the aperture of the first sheet metal part.

A closure assembly of this design ensures that there is almost no dead volume between the electrode-separator assembly and the closure assembly. The closure assembly comprises an integrated pole bushing, wherein the same metal component that realizes the bushing can also be welded to a metallic component of the electrode-separator assembly.

In preferred embodiments, the energy storage element is characterized by one of the immediately following features a. and b.:

a. The electrode-separator assembly comprises a current collector welded directly to the external side of the bottom that closes the tubular feedthrough on the second side.

b. The electrode-separator assembly comprises a current collector welded to a current conductor which is welded directly to the external side of the bottom closing the tubular feedthrough on the second side.

Feature a. above is very advantageous with regard to the factor energy density. The direct connection between the current collector and the bottom of the fixing segment contributes to a component reduction and to the elimination of dead volume.

In the case of the realization of feature b. above, a contact sheet metal member as described in WO 2017/215900 A1 or U.S. Pat. No. 7,364,817 B2 is preferably used as the current conductor.

### Housing

Preferably, the energy storage element is characterized by the features a. and b. immediately below:

a. The housing comprises a metallic housing part that includes a housing bottom, a circumferential side wall or several side walls and a terminal opening.

b. The closure assembly closes the terminal opening of the metal housing part.

Preferably, the housing is cylindrical or prismatic. In the first case, the metal housing part is preferably a housing cup with a circular base. The housing cup then comprises the circumferential side wall. In the second case, the base surface is preferably polygonal, in particular rectangular. The metal housing part then preferably comprises at least four side walls. The closure assembly preferably has the same shape as the base surface.

The closure assembly can be welded into the terminal opening. Depending on the individual case, the closure assembly can also be mechanically fixed in the opening.

In many embodiments, the components of the housing of the energy storage element, in particular the metallic housing part with the circumferential side wall or side walls and the terminal opening as well as external metallic components of the lid assembly, preferably consist of aluminum or an aluminum alloy.

Suitable aluminum alloys for the cup-shaped housing part and the cover plate are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

In other preferred embodiments, the housing components of the energy storage element consist of copper or nickel or a copper or nickel alloy or steel or nickel-plated steel.

Suitable stainless steels are, for example, stainless steels of type 1.4303 or 1.4404 or of type SUS304 or nickel-plated steels. In particular, materials of type EN CW-004A or EN CW-008A with a copper content of at least 99.9% can be used as copper alloys. Nickel alloys of the type NiFe, NiCu, CuNi, NiCr and NiCrFe are suitable.

In preferred embodiments, the energy storage element is characterized by at least one of the features a. to d. immediately below:

a. The housing bottom of the metallic housing part has a thickness in the range from 200 μm to 2000 μm.

b. The side wall or walls of the metallic housing part has or have a thickness in the range from 150 μm to 2000 μm.

c. The first sheet metal part has a thickness in the range from 0.1 mm to 1.5 mm, preferably in the range from 0.2 mm to 0.6 mm.

d. The second sheet metal part has a thickness in the range from 0.1 mm to 1.5 mm, preferably in the range from 0.2 mm to 0.6 mm.

The immediately preceding features a. to d. are preferably realized in combination.

### Seal

The seal is preferably a polymer material, for example a polyolefin or a polyamide or a polyether ketone.

In principle, however, the seal can also be made of glass or a ceramic material.

It is important that the seal has electrically insulating properties and—if a liquid electrolyte is used—that it is chemically stable against it.

Preferably, the seal has a thickness in the range from 0.1 mm to 1.5 mm, preferably in the range from 0.2 mm to 0.8 mm.

### Structure of the Electrode-Separator Assembly

It is further preferred that the energy storage element is characterized by the immediately following features a. to g:

a. The electrode-separator assembly comprises a first terminal end face and a second terminal end face.

b. The electrode-separator assembly comprises at least one anode with an anode current collector having a first edge and a second edge parallel thereto.

c. The anode current collector comprises a main region loaded with a layer of negative electrode material and a free edge strip extending along its first edge which is not loaded with the electrode material.

d. The electrode-separator assembly comprises at least one cathode with a cathode current collector having a first edge and a second edge parallel thereto.

e. The cathode current collector comprises a main region loaded with a layer of positive electrode material and a free edge strip extending along its first edge which is not loaded with the electrode material.

f. The anode and the cathode are arranged within the electrode-separator assembly in such a way that the first edge of the anode current collector protrudes from the first terminal end face and the first edge of the cathode current collector protrudes from the second terminal end face of the electrode-separator assembly.

g. The first edge of the anode current collector or the first edge of the cathode current collector is welded directly to the external side of the bottom that closes the tubular feedthrough on the second side.

If the housing of the energy storage element is prismatic, then the electrode-separator assembly is generally also prismatic. In this case, the electrode-separator assembly is preferably a prismatic stack comprising several anodes, cathodes and at least one separator, wherein the electrode-separator assembly within the stack always has the sequence anode/separator/cathode.

At least the anodes and cathodes preferably have a rectangular base surface, wherein the current collectors of the anodes and the cathodes each have the first edge and the second edge parallel thereto and each have the free edge strip along their first edge, which is not coated with the respective electrode material.

In the case of several separators between the anodes and cathodes, the separators preferably also have a rectangular base area. However, it is also possible to use a ribbon-shaped separator that separates several anodes and cathodes within the stack.

The first and second flat terminal end faces are, for example, two opposite or adjacent sides of the stack. The first edges of the anode current collectors protrude from one of these end faces and the first edges of the cathode current collectors protrude from the other.

As already explained above, the current conductor, which in one embodiment of the energy storage element is welded to a current collector and to the external side of the bottom, is preferably a contact sheet metal member. In preferred embodiments, this sits on the first edges of the anode current collectors or the first edges of the cathode current collectors and is connected to these by welding.

If the energy storage element is designed as a round cell, then the ribbon-shaped electrode-separator assembly preferably comprises ribbon-shaped electrodes and a ribbon-shaped separator or two ribbon-shaped separators, each of which has a first and a second longitudinal edge and two ends. The electrode-separator assembly comprises the electrodes and the separator or separators always with the sequence anode/separator/cathode.

Preferably, the ribbon-shaped anode, the ribbon-shaped cathode and the ribbon-shaped separator(s) are spirally wound. To produce the ribbon-shaped electrode-separator assembly, the ribbon-shaped electrodes are preferably fed to a winding device together with the ribbon-shaped separator(s) and are preferably spirally wound around a winding axis in the winding device. In some embodiments, the electrodes and the separator are wound onto a cylindrical or hollow-cylindrical winding core for this purpose, which is seated on a winding mandrel and remains in the winding after winding. The first edges of the anode current collector and the cathode current collector protrude from the end faces of the winding formed.

Preferably, the height of an energy storage element formed as a cylindrical round cell is in the range from 50 mm to 150 mm and its diameter is preferably in the region from 15 mm to 60 mm. Cylindrical round cells with these form factors are suitable for supplying power to electric drives in motor vehicles.

In embodiments in which the energy storage element is a cylindrical round cell, the anode current collector, the cathode current collector and the separator or separators preferably have the following dimensions:
A length in the range from 0.5 m to 25 m
A width in the range from 30 mm to 145 mm

### Preferred Embodiments of the Separator

Preferably, the separator or separators are formed from electrically insulating plastic films. It is preferable that the separators can be penetrated by the electrolyte. For this purpose, the plastic films used can have micropores, for example. The foil can consist of a polyolefin or a polyether ketone, for example. Nonwovens and fabrics made of plastic materials or other electrically insulating fabrics can also be used as separators. Separators with a thickness in the range from 5 μm to 50 μm are preferred.

In some preferred embodiments, separators are used which are coated or impregnated with ceramic particles (e.g. Al₂O₃ or SiO₂) on one or both sides.

In particular in prismatic embodiments of the energy storage element, the separator or separators of the assembly can also be one or more layers of a solid electrolyte.

In the case of the above described configuration of the energy storage element as a cylindrical round cell, it is preferred that the longitudinal edges of the separator or separators form the end faces of the electrode-separator assembly formed as a winding.

In the case of the described prismatic configuration of the energy storage element, it is preferred that the edges of the separator(s) form the end faces of the stack from which the edges of the current collectors protrude.

### Current Collectors

The current collectors of the energy storage element have the function of electrically contacting the electrochemically active components contained in the respective electrode material over as large an area as possible. Preferably, the current collectors consist of a metal or are at least metallized on the surface.

In the case of an energy storage element designed as a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are suitable as nickel alloys. Stainless steel can also be considered, for example type 1.4303 or 1.4404 or type SUS304.

In the case of an energy storage element designed as a lithium-ion cell according to the invention, aluminum or other electrically conductive materials, including aluminum alloys, are suitable as the metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a metal foil with a thickness in the region of 4 μm to 30 μm, in the case of the described configuration of the energy storage element as a cylindrical round cell, a ribbon-shaped metal foil with a thickness in the range from 4 μm to 30 μm.

In addition to foils, however, other strip-shaped substrates such as metallic or metallized nonwovens or open-pored metallic foams or expanded metals can also be used as current collectors.

The current collectors are preferably loaded with the respective electrode material on both sides.

It is further preferred that the edges or longitudinal edges of the anode current collector and/or the cathode current collector protruding from the terminal end faces of the winding or sides of the stack do not exceed 5000 μm, preferably not more than 3500 μm.

### Electrochemistry

In a further preferred embodiment, the energy storage element is characterized by one of the features a. and b. immediately below:

a. The energy storage element is a lithium-ion cell.

b. The energy storage element comprises a lithium-ion cell.

Feature a. refers in particular to the above described embodiment of the energy storage element as a cylindrical round cell or a button cell. In this embodiment, the energy storage element preferably comprises or is exactly one electrochemical cell.

Feature b. refers in particular to the above described prismatic embodiment of the energy storage element. In this embodiment, the energy storage element may also comprise more than one electrochemical cell.

Basically, all electrode materials known for secondary lithium-ion cells can be used for the electrodes of the energy storage element.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly intercalate and redeposit lithium, for example silicon oxide (in particular SiOₓ with 0<x<2), optionally in combination with carbon-based active materials. Tin, aluminum, antimony and silicon can form intermetallic phases with lithium. The capacity to absorb lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co₂O₂ (wherein x+y+z is typically 1) is also suitable, lithium manganese spinel (LMO) with the chemical formula LiMn₂O₄, or lithium nickel cobalt aluminum oxide (NCA) with the chemical formula LiNiₓCo_{y}Al_{z}O₂ (wherein x+y+z is typically 1). Derivatives thereof, for example lithium nickel manganese cobalt aluminum oxide (NMCA) with the chemical formula Li_{1.11} (Ni_{0.40}Mn_{0.39}Co_{0.16}Al_{0.05})_{0.89}O₂ or Li₁₊ₓM-O compounds and/or mixtures of the aforementioned materials can also be used. The cathode active materials are also preferably used in particulate form.

In addition, the electrodes of an energy storage element preferably contain an electrode binder and/or an additive to improve the electrical conductivity. The active materials are preferably embedded in a matrix of the electrode binder, wherein neighboring particles in the matrix are preferably in direct contact with each other. Conductive agents have the function of elevating the electrical conductivity of the electrodes. Common electrode binders are based, for example, on polyvinylidene fluoride (PVDF), (Li-) polyacrylate, styrene-butadiene rubber or carboxymethyl cellulose or mixtures of different binders. Common conductive agents are carbon black, fine graphite, carbon fibers, carbon nanotubes and metal powder.

The energy storage element preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato) borate (LiBOB).

The nominal capacity of a lithium-ion-based energy storage element designed as a cylindrical round cell is preferably up to 15000 mAh. With a form factor of 21×70, the energy storage element in one embodiment as a lithium-ion cell preferably has a nominal capacity in the range from 1500 mAh to 7000 mAh, preferably in the range from 3000 to 5500 mAh. With a form factor of 18×65, the cell in one embodiment as a lithium-ion cell preferably has a nominal capacity in the range from 1000 mAh to 5000 mAh, preferably in the range from 2000 to 4000 mAh.

In the European Union, manufacturers' information on the nominal capacity of secondary batteries is strictly regulated. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard and information on the nominal capacity of secondary lead-acid batteries must be based on measurements according to the IEC/EN 61056-1 standard. Any information on nominal capacities in the present application is preferably also based on these standards.

### Sodium-Ion-Based Embodiment

In further embodiments, the energy storage element may also be a sodium-ion cell, a potassium-ion cell, a calcium-ion cell, a magnesium-ion cell or an aluminum-ion cell. Among these variants, energy storage cells with sodium-ion cell chemistry are preferred.

Preferably, the sodium ion-based energy storage element comprises an electrolyte comprising at least one of the following solvents and at least one of the following conducting salts:
Organic carbonates, ethers, nitriles and mixtures thereof are suitable as solvents.
Preferred conducting salts are NaPF₆, sodium difluoro (oxalato) borate (NaBOB), NaBF₄, sodium bis(fluorosulfonyl)imide (NaFSI), sodium 2-trifluoromethyl-4,5-dicyanoimidazole (NaTDI), sodium bis(trifluoromethanesulfonyl)imide (NaTFSI), NaAsF₆, NaBF₄, NaClO₄, NaB(C₂O₄)₂, NaP(C₆H₄O₂)₃; NaCF₃SO₃, sodium triflate (NaTf) and Et₄NBF₄.

In preferred embodiments, additives can be added to the electrolyte.

The negative electrode material of an energy storage element based on sodium ions is, for example, one of the following materials:
carbon, especially hard carbon (pure or with nitrogen and/or phosphorus doping) or soft carbon or graphene-based materials, carbon nanotubes, graphite
phosphorus or sulphur
polyanions such as Na₂Ti₃O₇, Na₃Ti₂(PO₄)₃, TiP₂O₇, TiNb₂O₇, Na—Ti—(PO₄)₃, Na—V—(PO₄)₃

Transition metal oxides such as V₂O₅, MnO₂, TiO₂, Nb₂O₅, Fe₂O₃, Na₂Ti₃O₇, NaCrTiO₄, Na₄Ti₅O₁₂

Alternatively, a Na metal anode can also be used on the anode side.

The positive electrode material of an energy storage element based on sodium ions is, for example, one of the following materials:
polyanions: NaFePO₄ (Triphylit-Typ), Na₂Fe(P₂O₇), NaFe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, NaCoPO₄, Na₂CoPO₄F
silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

In addition, the electrodes of an energy storage element based on sodium ions preferably also contain an electrode binder and/or an additive to improve the electrical conductivity. In this respect, there is basically no difference to an embodiment based on lithium-ion technology.

Preferably, in an energy storage element based on sodium-ion technology, both the anode and the cathode current collector consist of aluminum or an aluminum alloy. The housing and any other current conductors within the housing can also consist of aluminum or the aluminum alloy.

### Contact Sheet Metal Member

It is further preferred that the electrochemical energy storage element is characterized by the immediately following features a. and b. or a. and c:

a. The energy storage element comprises a contact sheet metal member which sits directly on the first edge of the anode current collector or on the first edge of the cathode current collector.

b. The contact sheet metal member is the current conductor that is welded to the external side of the bottom that closes the tubular bushing on the second side.

c. The bottom that closes the tubular feedthrough on the second side is the contact sheet metal member.

The contact sheet metal member has already been mentioned above. It consists of aluminum or nickel or copper or titanium or stainless steel, for example.

Immediately preceding feature c. is preferred.

### Bottom-Side Contacting of Current Collectors

In preferred embodiments, the electrochemical energy storage element is characterized by the feature a. immediately below:

a. The first edge of the cathode current collector or the first edge of the anode current collector, which is not in direct contact with the contact sheet metal member, is electrically connected to the housing bottom.

It is preferred that the first edge of the cathode current collector or the anode current collector, which is not in direct contact with the contact sheet metal member, is welded to the housing bottom.

### Design of the Fixing and Contact Segments as Well as the Tubular Feed-Through

The fixing segment is preferably characterized by the following features:

a. The bottom, which closes the tubular feedthrough on the second side, has at least one bead.

b. The at least one bead is elongated.

c. The at least one bead occurs on the inside of the bottom as a depression and on the external side of the bottom as an elevation.

Preferably, the current collector, which is welded directly to the external side of the bottom that closes the tubular feedthrough on the second side, is welded to the elevation.

In some embodiments, it has proven advantageous to subject the edge of the current collector, which is welded to the elevation, to a pre-treatment so that the contact between the housing bottom and the current collector is improved. In particular, at least one depression can be made in the edge, which corresponds to the at least one bead or the elongated elevation on the inside of the housing bottom.

The edge of the current collector may also have been subjected to directional forming by pre-treatment. For example, it can be bent in a defined direction.

The contact segment is preferably characterized by the following features:

a. It comprises a ring-shaped region around the aperture.

b. It comprises at least one further region that can be bent and extends from the ring-shaped region.

A plug contact, for example, can be connected via the further region that can be bent and is formed at the ring-shaped region.

In some embodiments, the tubular feedthrough has a circular cross-section, in others an oval cross-section. Elongated and angular cross-sections, such as a hexagonal cross-section, may also be preferred. Accordingly, the region around the aperture does not necessarily have to be annular.

Further features and advantages of the invention are apparent from the claims and from the following description of preferred examples in conjunction with the drawings. The individual features may be realized individually or in combination with each other.

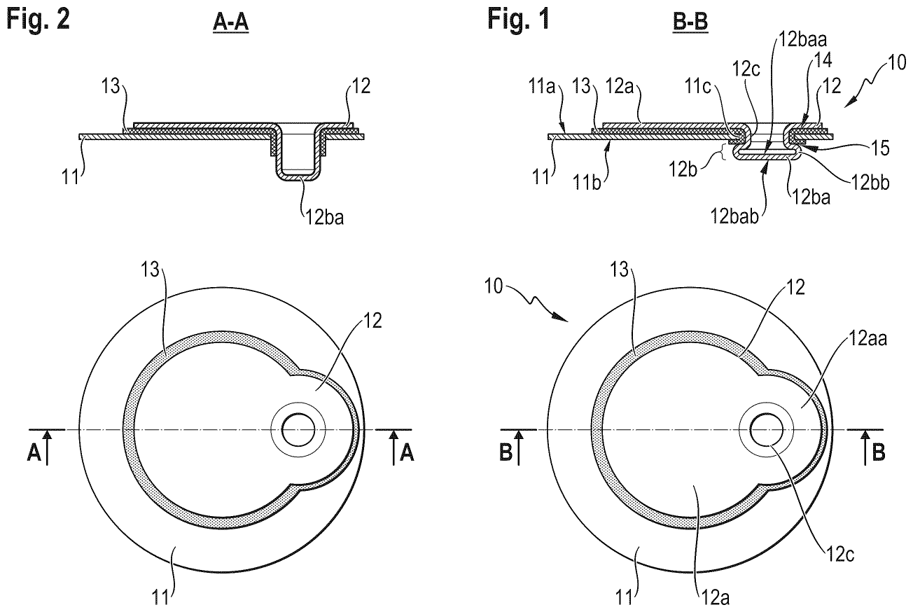

FIG. 1 shows the manufacture of the closure assembly 10 of an energy storage element 100. The lower illustration is a top view from above, the upper illustration is a section along the axis BB.

It comprises a first sheet metal part 11 with a first side 11a, an opposite second side 11b and an aperture 11c, and a second sheet metal part 12 with a contact segment 12a, a fixing segment 12b and a tubular feedthrough 12c, wherein the contact segment 12a extends on the first side 11a and the fixing segment 12b extends on the second side 11b of the first sheet metal part 11 and the tubular feedthrough 12c connects the two segments 12a and 12b through the aperture 11c. Further, the closure assembly 10 comprises the electrically insulating seal 13 disposed between the first sheet metal part 11 and the second sheet metal part 12 and electrically insulating them from each other. A first part of the fixing segment 12b is formed as a bottom 12ba, which closes the tubular feedthrough 12c on the second side 11b, wherein the bottom 12ba has an inner side 12baa directed in the direction of the feedthrough 12c and an outer side 12bab directed in an opposite direction. A second part of the fixing segment 12b is formed as a projection 12bb, which ensures a form-fitting fixation of the tubular feedthrough 12c in the aperture 11c and thus ensures that the first sheet metal part 11 and the second sheet metal part 12 firmly hold together. Here, the first side 11a of the first sheet metal part 11 and the contact segment 12a delimit a first gap 14, while the second side 11b of the first sheet metal part 11 and the projection 12bb delimit a second gap 15. The seal 13 fills the first gap 14 and the second gap 15 in such a way that the first side 11a is separated from the second side 11b in a gas-tight and/or liquid-tight manner.

In the present case, the closure assembly 10 has an asymmetrical geometry. The first sheet metal part 11 is designed as a circular disk. However, the aperture 11c is not arranged in the center of the disc but offset towards the edge of the disc. The contact segment 12a, on the other hand, extends over the center of the disc so that a current can be drawn there, even if the pole feedthrough in the form of the tubular feedthrough 12c and the surrounding seal 13 is located in a different area of the disc. This can be very advantageous in certain applications.

If the sheet metal parts 11 and 12 and the seal 13 are adapted accordingly, it is easily possible to place the aperture 11c or the feedthrough 12c in the center of the closure assembly 10.

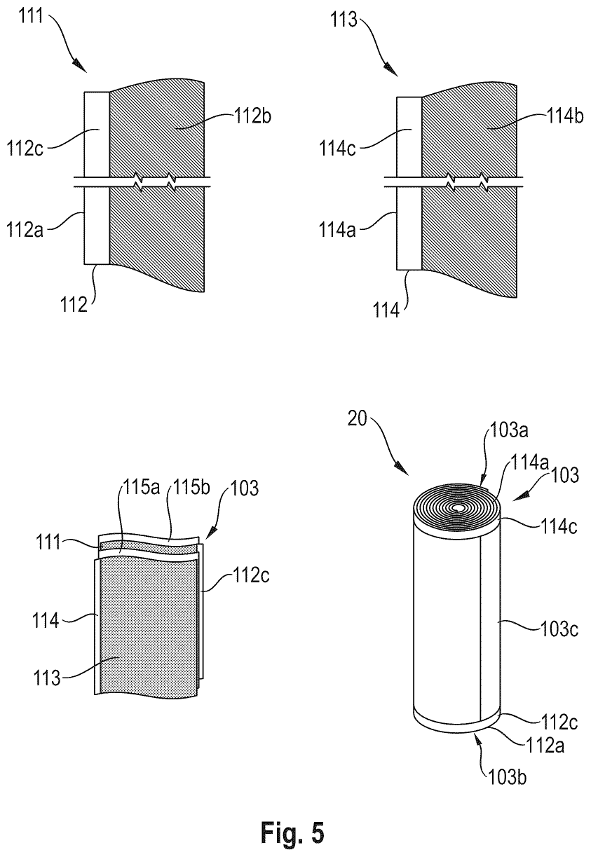

Closure assemblies in the embodiment shown are preferably used in combination with a contact sheet metal member which sits directly on the first edge 112a of the anode current collector 112 or on the first edge 114a of the cathode current collector 114 of an electrode-separator assembly 20, as shown in FIG. 5, and is preferably connected to this edge by welding. In these cases, the contact sheet metal member is preferably connected to the bottom 12ba by welding.

For example, the pre-product shown in FIG. 2 can be used to manufacture the closure assembly shown in FIG. 1. Here too, the lower illustration is a top view from above and the upper illustration is a section along the axis AA.

The first sheet metal part 11 already has its final shape, while the second sheet metal part 12 still needs to be formed. The forming can be carried out, for example, by means of a punch that is pressed against the bottom 12ba from below. The projection 12bb shown in FIG. 1 as well as the gap 14 and the gap 15 are then formed. At the same time, the seal 13 is compressed at least in sub-regions within the gap 14 and the gap 15.

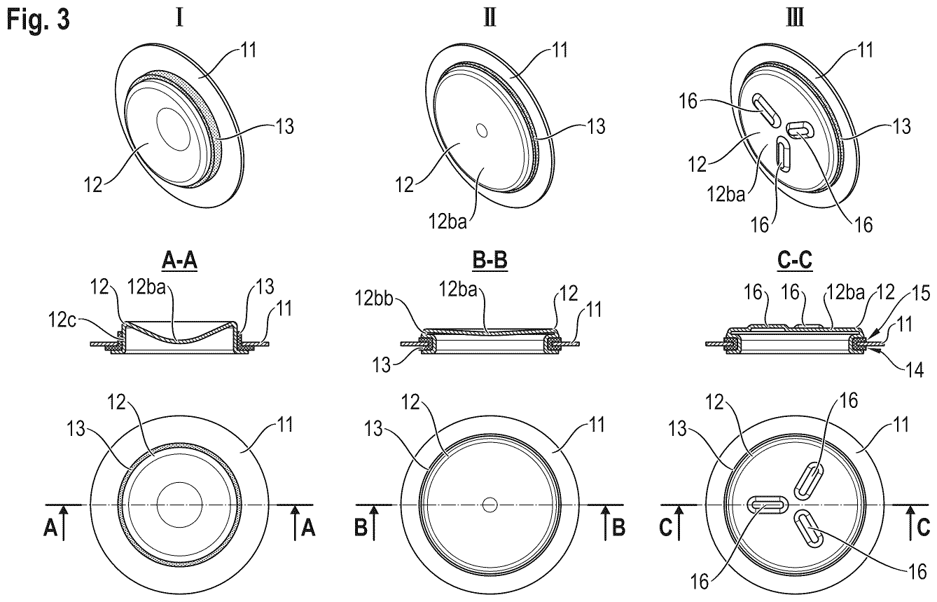

The procedure shown in FIG. 3 starts also from a pre-product (step I), which is composed of the sheet metal part 11, the sheet metal part 12 and the seal 13. The sheet metal part 12 comprises the bottom 12ba, which is curved inwards. The sheet metal part 12 is inserted into the aperture 11c with the bottom 12ba in front together with the seal 13. This is followed by forming (step II), in which the projection 12bb as well as the gap 14 and the gap 15 are formed. At the same time, the seal 13 is compressed within the gap 14 and the gap 15. Finally, three elongated beads 16 are embossed into the bottom 12ba. These beads 16 serve to make electrical contact with the electrode-separator assembly 20 of an energy storage element 100.

The illustrations below are each a vertical top view from below. The top illustrations are perspective views of the underside of the lid assembly. The illustrations in the middle are sections along the axes AA, BB and CC.

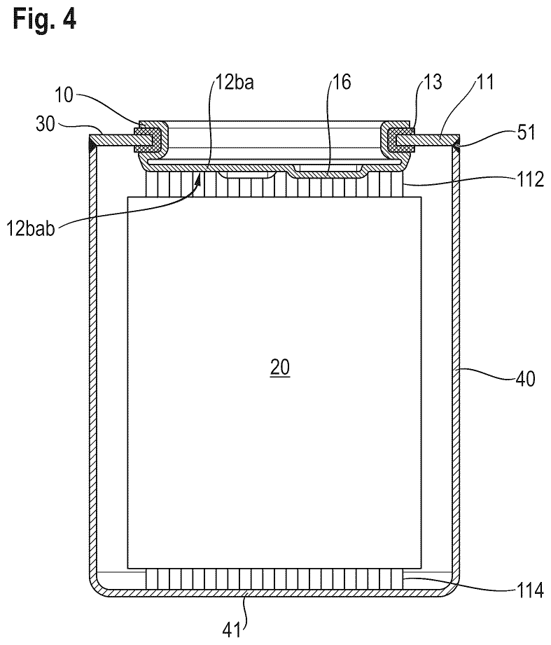

The energy storage element 100, shown in section in FIG. 4, comprises the electrode-separator assembly 20 and the housing 30, which encloses the electrode-separator assembly 20. The housing 30 consists essentially of the closure assembly 10 and the metal cup 40, wherein the closure assembly corresponds to that shown in FIG. 3. The electrode-separator assembly 20 comprises a current collector 112 welded directly to the external side 12bab of the bottom 12ba, which closes the tubular feedthrough 12c on the second side 11b. The current collector 112 is coated with a negative electrode material (see FIG. 5), but not in the edge region which is welded to the bottom 12ba of the closure component 10. A second current collector 114, which is coated with a positive electrode material in some areas, is welded to the housing bottom 41 of the metal cup 40. The metal cup 40 preferably consists of aluminum.

A preferred structure of the electrode-separator assembly 20 shown without details in FIG. 4 is shown in FIG. 5. The ribbon-shaped electrode-separator assembly 20 comprises a ribbon-shaped anode 111 with a ribbon-shaped anode current collector 112 and a ribbon-shaped cathode 113 with a ribbon-shaped cathode current collector 114. The anode current collector 112 is preferably a foil made of copper or nickel. The cathode current collector 114 is preferably an aluminum foil. Both the anode current collector 112 and the cathode current collector 114 have a first longitudinal edge 112a, 114a and a second longitudinal edge, a main region 112b, 114b and a free edge strip 112c, 114c. The main regions 112b, 114b are loaded with a layer of electrode material, in the case of the anode 111 with negative electrode material, in the case of the cathode 113 with positive electrode material. The free edge strips 112c, 114c extend along the respective first longitudinal edge 112a, 114a and are not loaded with electrode material. Both electrodes are shown individually in an unwound state. Within the wound electrode-separator assembly 103, the anode 111 and the cathode 113 are offset from each other such that the first longitudinal edge 114a of the cathode current collector 114 protrudes from the first terminal end face 103a of the electrode-separator assembly 103. The first longitudinal edge 112a of the anode current collector 112 protrudes from the second terminal end face 103c of the electrode-separator assembly. This can be clearly seen in the illustration at the bottom right. The staggered arrangement can be seen in the illustration on the bottom left. Two ribbon-shaped separators 115a and 115b are also shown there, which separate the electrodes 111, 113 from each other in the winding. The winding shell 103b of the electrode-separator assembly 103 is usually formed by a plastic film.

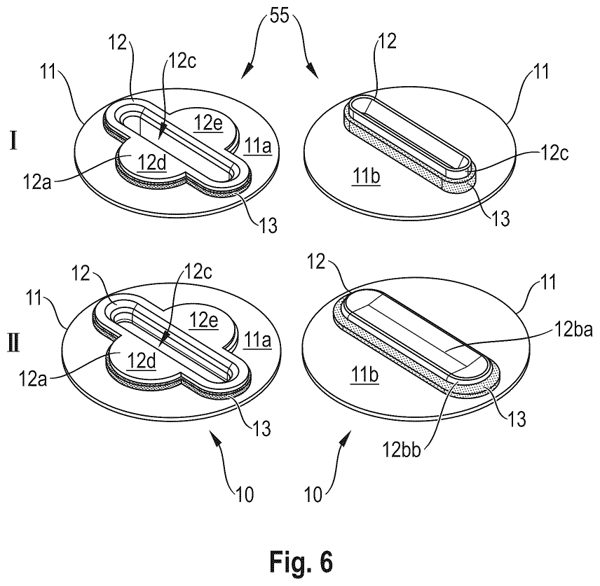

The procedure shown in FIG. 6 starts from pre-product 55, which is composed of the first circular sheet metal part 11, the second sheet metal part 12 and the seal 13. On the left, the pre-product is shown in a plan view of the first side 11a of the sheet metal part 11, and on the right in a plan view of the second side 11b of the sheet metal part 11.

The second sheet metal part 12 comprises the contact segment 12a and a tubular feedthrough 12c. The contact segment 12a extends on the first side 11a of the first sheet metal part 11 and is characterized by two symmetrical contact areas 12d and 12e, to which current conductors can be welded. The tubular feedthrough 12c is elongated.

The sheet metal part 12 is inserted with the bottom 12ba (curved inwards and not visible in the illustration of the pre-product) together with the seal 13 into an aperture in the sheet metal part 11. The aperture is elongated and extends through the center of the sheet metal part 11. Its length is more than two thirds of the diameter of the sheet metal part 11. The shape of the tubular feedthrough 12c is adapted to this.

A forming process that leads to the formation of the closure assembly 10 involves bending the part of the sheet metal part 12 that is guided through the aperture outwards to form the projection 12bb. This reveals the bottom 12ba that is curved inwards in the pre-product 55. For example, the edge of a current collector can be welded to the bottom 12a.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An electrochemical energy storage element, comprising:
an electrode-separator assembly comprising a current collector; and
a housing enclosing the electrode-separator assembly, the housing comprising a closure assembly, the closure assembly comprising:
a first sheet metal part comprising a first side, an opposite second side, and an aperture,
a second sheet metal part comprising a contact segment extending on the first side of the first sheet metal part, a fixing segment extending on the second side of the first sheet metal part, and a tubular feedthrough connecting the connecting the contact segment and the fixing segment through the aperture, and
an electrically insulating seal disposed between the first sheet metal part and the second sheet metal part,
wherein a first part of the fixing segment is formed as a bottom that closes the tubular feedthrough on the second side of the first sheet metal part, the bottom comprising an internal side and an external side, the internal side directed in a direction of the feedthrough and the external side directed in an opposite direction,
wherein a second part of the fixing segment is formed as a projection configured to provide a form-fitting fixation of the tubular feedthrough in the aperture,
wherein the first side of the first metal sheet part and the contact segment delimit a first gap,
wherein the second side of the first metal sheet and the projection delimit a second gap,
wherein the electrically insulating seal fills the first gap and the second gap to separate the first and second sides in a gas- and/or liquid-tight manner, and
wherein the electrode-separator assembly is connected to the external side of the bottom by:
a weld formed directly between the current collector and the external side of the bottom, or
a weld formed directly between the current collector and a current conductor that is welded directly to the external side of the bottom.

2. The electrochemical energy storage element according to claim 1, wherein the housing further comprises a metallic housing part that comprises:
a housing bottom
a circumferential side wall or several side walls, and
a terminal opening, and
wherein the closure assembly closes the terminal opening of the metal housing part.

3. The electrochemical energy storage element according to claim 1, wherein the electrode-separator assembly comprises:
an anode comprising an anode current collector comprising a first edge, a second edge parallel to the first edge, a main region loaded with a layer of negative electrode material, and a free edge strip not loaded with the negative electrode material extending along the first edge,
a cathode comprising a cathode current collector comprising a first edge, a second edge parallel to the first edge, a main region loaded with a layer of positive electrode material, and a free edge strip not loaded with the positive electrode material extending along the first edge,
wherein the electrode separator assembly forms a firsts terminal end face and a second terminal end face,
wherein the first edge of the anode current collector protrudes from the first terminal end face and the first edge of the cathode current collector protrudes from the second terminal end face, and
wherein the first edge of the anode current collector or the first edge of the cathode current collector is welded directly to the external side of the bottom.

4. The electrochemical energy storage element of claim 3, wherein at least one of:
the energy storage element further comprises a contact sheet metal member directly seated on the first edge of the anode current collector or on the first edge of the cathode current collector,
the contact sheet metal member is the current conductor that is welded to the external side of the bottom, or
the contact sheet metal member is the bottom.

5. The electrochemical energy storage element according to claim 3, wherein the first edge of the anode current collector or the cathode current collector, which is not welded to the external side of the bottom, is electrically connected to the housing bottom.

6. The electrochemical energy storage element according to claim 1, wherein at least one of:
the bottom has at least one bead,
the at least one bead is elongated, or
the at least one bead occurs on the internal side of the bottom as a depression and on the external side of the bottom as an elevation.

7. The electrochemical energy storage element according to claim 1, wherein at least one of:
the contact segment comprises a ring-shaped region around the aperture, or
the contact segment comprises at least one further region configured to be bent, the at least one further region extending from the ring-shaped region.

8. The electrochemical energy storage element according to claim 1, wherein the tubular feedthrough has an elongated form.
